(19) United States
(12) Patent Application Publication
(10) Pub. No.: US 2009/0117381 A1
(43) Pub. Date: May 7, 2009

(54) Acryl Microbead Having Marron Particle Size Distribution and Method of Preparing Thereof

(76) Inventors: Jae Eock Cho, Daejeon (KR); Se Jin Oh, Seoul (KR); Seok Heon Oh, Daejeon (KR)

Correspondence Address: ABELMAN, FRAYNE & SCHWAB, 666 THIRD AVENUE, 10TH FLOOR, NEW YORK, NY, 10017, US

(21) Appl. No.: 11/991,673

(22) PCT Filed: Aug. 31, 2006
(86) PCT No.: PCT/KR2006/003445

§ 371 Date: Mar. 6, 2008

(30) Foreign Application Priority Data
Sep. 15, 2005 (KR) 10-2005-0085819

(51) Int. Cl. B32B 5/16; C08L 33/08; B32B 27/00

(52) U.S. Cl. 428/402; 524/563

(57) ABSTRACT

Disclosed herein are acryl microbeads having a narrow particle size distribution and a method of preparing the same. In a method of preparing acryl microbeads through polymerization by stirring a polymerization composition containing vinyl acrylate monomers, an initiator and a dispersion stabilizer at a high speed to form microdroplets and increasing a reaction temperature to induce the polymerization reaction of the monomers within the microdroplets, a low molecular weight seed particle capable of absorbing vinyl acrylate monomers dissolved in a reaction medium outside the microdroplets is supplied at the time of the polymerization reaction, and thus the acryl microbeads have a narrow particle size distribution. The microbeads, which are almost completely free of fine and coarse particles and thus need no sorting process, which range in size from 1 to 50 μm, and which have a narrow particle size distribution can be prepared at a high yield without using a polymerization inhibitor. Exhibiting excellent physicochemical properties including color, transparency, etc., the microbeads can find a wide spectrum of applications in various industries including optical, cosmetic, and food industries.

### TECHNICAL FIELD

The present invention relates to acryl microbeads with a narrow particle size distribution and a method of preparing the same. More particularly, the present invention relates to microbeads ranging in particle size from 1 to 50 μm, having a narrow particle size distribution, which show excellent physicochemical properties, and a method of preparing such microbeads through polymerization, featuring the addition of low-molecular weight seed particles, capable of absorbing monomers dissolved in a reaction medium so as to control the size of the finally produced microbeads and produce fine and coarse particles through extrusion.

### BACKGROUND ART

Microbeads have found a broad range of applications, including paints, ink, column fillers, toners, artificial marbles, cosmetics, etc. Recently, the application of microbeads has been further extended to fine products including spacers, electroconductive balls, light diffusers, etc., and thus the microbeads are required to become more precise. There are preparation methods of microbeads well known in the art, such as suspension polymerization, dispersion polymerization, emulsion polymerization, non-emulsion polymerization and seed polymerization.

According to a suspension polymerization method, monomers are dispersed in the inactive medium water through stirring in the presence of a dispersion stabilizer, and are polymerized with the aid of an initiator in an emulsion state. Because it is contained in monomer droplets, the oil-soluble initiator thermally decomposes to produce radicals which trigger the polymerization. Droplets are stabilized by the dispersion stabilizer, but because the monomer droplets become viscous as the polymerization proceeds, the monomers are consolidated together in collisions therebetween, or are split by the shearing force of the stirrer, thereby producing beads having a wide particle size distribution.

Successful suspension polymerization requires monomers which are sparsely soluble in the reaction medium water and have high boiling points, as well as an initiator which is oil-soluble and has low solubility in water. However, acryl monomers having low molecular weights, such as methyl methacrylate, have high water solubility (i.e., 1.59%, 20° C.), so that a part thereof does not form droplets, but is dissolved in the reaction medium water. Further, the amount of monomers dissolved in water increases with the reaction temperature. Most of the initiator is present within monomer droplets which thus react rapidly to form polymer beads, and the polymerization of the monomers dissolved in the water occurs later. Since they are low in water solubility and are not stabilized by the dispersion stabilizer, the acryl polymers produced through the polymerization of the monomers dissolved in water exist as fine particles having a size from 0.1 to 0.5 μm.

Many attempts have been made to suppress the production of such fine particles not only because they decrease the yield, but also because they are difficult to remove through separation to increase the contamination degree of waste water and are apt to adhere to the beads and thus degrade the physical properties of the beads.

The polymerization of the monomers dissolved in the medium is typically suppressed with water-soluble polymerization inhibitors. For example, the use of ammonium thiocyanate (NH₄SCN) in an amount from 0.01 to 10% was introduced in Japanese Pat. Laid-Open Publication No. Sho. 55-82125. The use of cupric chloride (CuCl₂) as a polymerization inhibitor is described in Japanese Pat. Laid-Open Publication No. Sho. 60-8302, sodium nitrite (NaNO₂) in both Japanese Pat. Laid-Open Publication Nos. Sho. 62-205108 and Hei. 2-284905, and a combination of sodium nitrite and hydroquinone (HOC₆H₄OH) in Japanese Pat. Laid-Open Publication No. Hei. 3-237105. Japanese Pat. Laid-Open Publication No. Sho. 61-255323 discloses the use of water-soluble mercaptan. Japanese Pat. Laid-Open Publication Nos. Hei. 6-73106 and Hei. 7-165847 describe mercaptan (—SH), disulfide (—S—S—), or nitrobenzoic acid acting to suppress the formation of fine particles on beads. Japanese Pat. Laid-Open Publication No. Hei. 7-316209 suggests the use of aromatic compounds containing at least one nitro group (NO₂—), one sodium sulfonate group (—SO₃Na), and one secondary amino group.

However, these methods suffer from several drawbacks. First, the reaction of monomers is suppressed at a low temperature in the presence of such a polymerization inhibitor, but proceeds at high temperatures to produce cake-like products on the inner wall of the reactor or on the surface of the stirrer. When combined with the product microbeads, the by-products have a significantly negative effect on the particle size distribution of the microbeads. Secondly, the particle size distribution of the microbeads thus produced increases with the use of the polymerization inhibitor. Finally, as the amount of the polymerization initiator increases, the beads become wider in particle size distribution. Finally, a large quantity of the polymerization initiator makes the beads colored or cloudy/opaque. Such colored microbeads are difficult to use in optical products.

### DISCLOSURE OF THE INVENTION

### Technical Problem

Leading to the present invention, intensive and thorough research into the production of acryl microbeads that are so homogeneous in particle size that they need no sorting process, without the concomitant production of fine and coarse particles, conducted by the present inventors, resulted in the finding that there is a difference between the reaction rate of microdroplets containing vinyl acrylate monomers, initiators and dispersion stabilizers and the reaction rate of acrylate monomers dissolved in a reaction medium outside the microdroplets, and that the addition of low-molecular weight seed particles capable of absorbing the monomers dissolved in the reaction medium allows the monomers to be polymerized into beads having desired sizes without additives including a polymerization initiator, thereby preparing microbeads showing a narrow particle size distribution and excellent physicochemical properties at high yield.

Accordingly, it is an object of the present invention to provide a method of preparing microbeads having a low particle size distribution at high yield, with a significant reduction in the concomitant production of fine and coarse particles.

It is another object of the present invention to provide acryl microbeads ranging in particle size from 1 to 50 μm, which are free of fine and coarse particles and exhibit desirable physicochemical properties, such as color or transparency.

### Technical Solution

In order to accomplish the above objects, one aspect of the present invention provides a method of preparing acryl microbeads through polymerization by stirring a polymerization composition containing vinyl acrylate monomers, an initiator and a dispersion stabilizer at a high speed to form microdroplets, and increasing the reaction temperature to induce the polymerization reaction of the monomers within the microdroplets, wherein a low molecular weight seed particle capable of absorbing vinyl acrylate monomers dissolved in a reaction medium outside the microdroplets is supplied at the time of the polymerization reaction, such that the acryl microbeads have a narrow particle size distribution.

In order to accomplish the above objects, another aspect of the present invention provides acryl microbeads, prepared by the method, which are free of particles smaller than 0.5 μm or larger than 50 μm, range from in particle size from 1 to 50 μm, and can be applied to various products in optical, food and cosmetic fields, thanks to their excellent color and transparency.

### ADVANTAGEOUS EFFECT

As described hitherto, the method according to the present invention can prepare microbeads ranging in size from 1 to 50 μm, having a narrow particle size distribution, at a high yield without using a polymerization inhibitor, which are almost completely free of fine and coarse particles and thus require no sorting processes.

Exhibiting excellent physicochemical properties including color, transparency, etc., in addition, the microbeads prepared according to the present invention can find a wide spectrum of applications in various industries including optical, cosmetic, and food industries. Further, the absence of additives is expected to make the microbeads particularly valuable in optical applications.

### BRIEF DESCRIPTION OF THE DRAWINGS

FIG. 1. is a graph showing the particle size distribution of microbeads prepared according to an embodiment of the present invention;

FIG. 2 is a graph showing the particle size distribution of microbeads prepared according to another embodiment of the present invention;

FIG. 3 is a graph showing the particle size distribution of microbeads prepared according to a conventional method; and

FIG. 4 is a graph showing the particle size distribution of microbeads prepared using high-molecular weight seed particles.

### BEST MODE FOR CARRYING OUT THE INVENTION

Below, a detailed description will be given of the present invention.

As described above, the present invention is based on the finding that when microbeads are prepared through a polymerization method, the reaction rate of microdroplets containing vinyl acrylate monomers, initiators, and dispersion stabilizers differs from that of acryl monomers which are dissolved in the reaction medium (e.g., water) outside the microdroplets, so that they can form fine particles.

In more detail, when polymerization is initiated at a predetermined reaction temperature, the vinyl acrylate monomers, which are contained together with initiators and dispersion stabilizers in microdroplets, are rapidly polymerized due to the initiators into solid beads inside viscous droplets, whereas vinyl acrylate monomers dissolved in the reaction medium outside the microdroplets remain unreacted for a significant time period.

In a state where polymerization occurs in the microdroplets and the monomers dissolved in the reaction medium outside the microdroplets remain unreacted, if non-crosslinking polymeric seed particles capable of absorbing the monomers dissolved in the reaction medium are added, the monomers are absorbed onto the seed particles and swollen. After sufficient absorption of the monomers onto the seeds is achieved, the temperature is increased to completely polymerize the monomers into microbeads having a desired particle size in a controllable manner without the production of fine and coarse particles.

The reaction temperature, the reaction time, and the feeding amount and time of the seed particles capable of absorbing the dissolved monomers are very important in determining the particle size and size distribution of the microbeads produced, and a full understanding of the reaction rate of monomers used in polymerization must be obtained in advance.

(1) Synthesis of Seed Particles Capable of Absorbing Water-Soluble Monomers Dissolved in Reaction Medium

In order to achieve the present invention, seed particles capable of absorbing monomers dissolved in a reaction medium need to be synthesized. As long as it can control the molecular weight of the seed particles, which is the most important factor when determining the absorption rate of monomers, any synthesis method can be used for the seed particles.

In accordance with the present invention, the seed particles useful in the polymerization are acrylic or styrenic polymer particles or vinyl acrylate monomer-compatible polymer particles ranging in weight average molecular weight preferably from 10,000 to 200,000 and more preferably from 50,000 to 100,000. When the seed particles have a molecular weight larger than 200,000, the absorption of the monomers onto the seeds is too slow to achieve the goal. On the other hand, seed particles smaller than the lower limit of the particle size range results in an absorption rate that is excessively fast. In this case, when the seeds are added early, monomers rapidly come out of the droplets, resulting in microbeads that are smaller than desired sizes. In the present invention, the material and size of the seed particles are determined in consideration of compatibility with the monomers, the particle size obtained upon polymerization after swelling, and the size of the product.

In accordance with the present invention, the seed particles may be synthesized through suspension polymerization, dispersion polymerization or non-emulsification polymerization. Examples of seed particles useful in the present invention include particles made from acrylates, such as methyl (meth)acrylate, ethyl (meth)acrylate, n-propyl acrylate, isopropyl acrylate, butyl acrylate and the like, styrene compounds, such as paramethyl styrene, paraethyl styrene, metamethylstyrene, metaethylstyrene, metahalostyrene, parahalostyrene and the like, and vinyl monomers polymerizable through radical polymerization, such as acrylonitrile, acrylamide and N-vinyl-2-pyrrolidone, but are not limited thereto. Optionally, a chain transfer agent may be used in order to control the molecular weight of the polymer.

(2) Suspension Polymerization of Acryl Monomers

A predetermined amount (e.g., 7 kg) of a suspension polymerization solution is prepared from a mixture of 15˜30 weight parts of acryl vinyl monomers containing 0.1˜1% of an oil-soluble initiator and 85˜70 weight parts of an aqueous solution containing 0.8˜2 weight parts of a dispersion stabilizer.

Examples of the acryl vinyl monomer useful in the present invention include acryl monomers, such as methyl(meth)acrylate, ethyl(meth)acrylate, normal propyl(meth)acrylate, isopropyl(meth)acrylate, butyl(meth)acrylate and so on, crosslinkable monomers, such as ethyleneglycol di(meth)acrylate, propyleneglycol di(meth)acrylate, pentaerythritol tri(meth)acrylate and the like, and combinations thereof.

As the dispersion stabilizer, a natural polymer or derivative thereof, such as gelatin, starch, carboxymethylcellulose (CMC), etc., a synthetic polymer, such as polyvinyl alcohol, partially saponified polyvinyl alcohol, polyacrylic acid salts, etc., or a powdered sparsely soluble salt, such as BaSO₄, CaSO₄, CaSO₃, MgCO₃, BaCO₃, CaCO₃, Ca₃(PO₄)₂, etc. may be used.

The reaction solution is homogenized using a homo mixer for a predetermined period of time (e.g., 10 min) to form microdroplets having a desired size. The size of the finally obtained beads can be controlled by adjusting the size of the microdroplets by changing the stirring speed and time of the homo mixer. After being formed in a desired size, the microdroplets are fed into a temperature-controllable reactor equipped with a nitrogen inlet and a fluxer (for example, a 10 liter double jacket reactor) and stirred. The inside of the reactor is purged with nitrogen gas for a predetermined time (e.g., 5 min) and maintained at a predetermined temperature.

In order to set forth the temperature of the reactor, the decomposition temperature of the initiator must be considered, and it is very important to control the temperature of the reactor so that the temperature in the automatic acceleration step does not increase. A reaction temperature exceeding the set point would cause the acryl monomers dissolved in water to react with each other to form fine particles. Accordingly, the temperature of the reactor is preferably maintained between 65° C. and 70° C. in accordance with the present invention.

(3) Feeding of Seed Particle Capable of Absorbing Monomers dissolved in Reaction Medium

When the reaction reaches an automatic acceleration step, the microdroplets increase in viscosity and then are changed into solid particles. At this time, a dispersion of the low-molecular weight seed particles synthesized in step (1) is fed into the reactor. Having significant influence on the particle size distribution of the finally obtained microbeads, the amount, size and feeding time of the seed particles must be determined in consideration of various circumstances, including the size of the microbeads polymerized from the microdroplets. Once fed, the seed particles absorb the monomers dissolved in the aqueous solution thereonto and swell.

If the feeding time point is too early, monomers are supplied from the microdroplets as well as the water, thus obtaining microbeads which are smaller in size than expected. Thus, a suitable feeding point occurs when the polymerization within the microdroplets including the oil-soluble initiator has advanced to some degree while the monomers dissolved in the reaction medium remain unreacted. The seed particles may be supplied in an early stage of the reaction. In more detail, the feeding of the seeds is preferably conducted when the temperature of the reactor reaches 65° C. to 70° C. within 30 min to 1.5 hours after the automatic acceleration step has been initiated.

If a sufficient amount of the monomers dissolved in the reaction medium is absorbed by the seeds, the reaction temperature is increased for the completion of polymerization in the microdroplets and on the seeds. Once polymerized, the microbeads are washed and dried. The microbeads prepared in accordance with the present invention are found to be free of fine particles ranging in size from 0.1 to 0.5 μm and coarse particles larger than 50 μm, and thus are sufficiently narrow in particle size distribution that they need no sorting processes. In contrast to conventional microbeads, the microbeads of the present invention are prepared in the absence of a polymerization inhibitor, and thus can be obtained at high yield in addition to showing excellent physical properties including color, transparency, etc.

### Modes for Invention

A better understanding of the present invention may be realized by reading the following examples, which are set forth to illustrate, but are not to be construed to limit the present invention.

### EXAMPLE 1

Into a 10 liter reactor were added 2 kg of methyl methacrylate and 15.0 g of the oil-soluble initiator benzoylperoxide, which was then completely dissolved by stirring. 5 kg of a 1.5% aqueous solution of polyvinyl alcohol having a saponification degree of 78˜88% was added to the reactor, followed by stirring for 10 min with a homogenizer to produce microdroplets 8 μm in size on average.

This reaction solution was fed into a 10-liter, temperature-controllable, double jacket reactor equipped with a nitrogen inlet and a flux means, and stirred. The inside of the reactor was purged by feeding nitrogen for 5 min, and was maintained at 70° C.

One hour after the temperature of the reactor reached 70° C., a water-dispersed solution, in which 10 g of 2.3 μm monodisperse seed particles showing CV 10 or less were dispersed in 30 g of a 1% aqueous solution of polyvinyl alcohol, was fed into the reactor. The monodisperse seed particles were obtained by sorting the polydisperse beads, having a weight average molecular weight of 75,000, prepared from methyl methacrylate and polyvinyl alcohol in the presence of a dispersion stabilizer through suspension polymerization. The temperature of the reactor was maintained at 70° C. for one additional hour after the feeding of the seed particles, and was then increased to a temperature of 90° C., at which polymerization was conducted for an additional four hours.

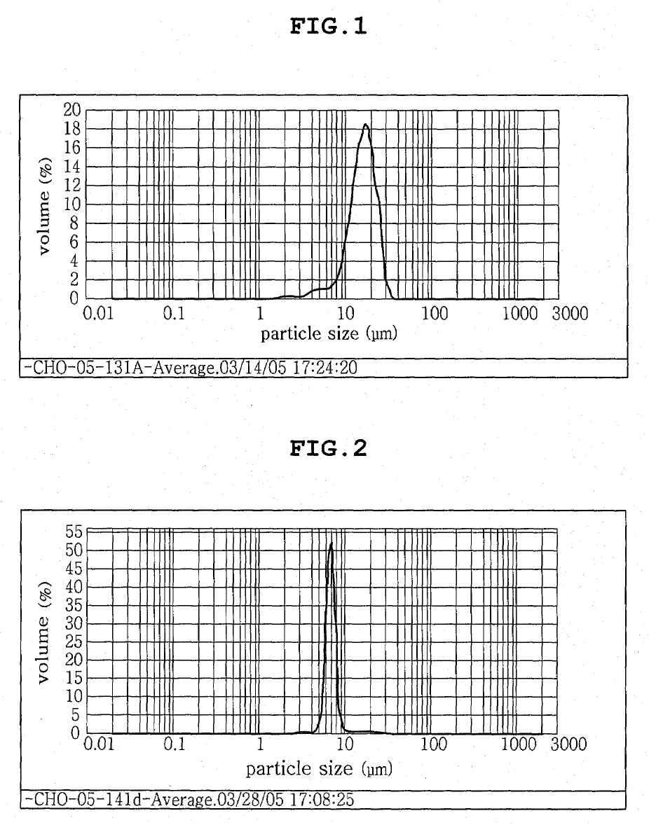

The microbeads thus prepared were found to be free of particles having a diameter smaller than 1 μm or larger than 40 μm according to measurements of average size made using a Mastersizer, manufactured by Malvern. The analysis results of size distribution are shown in FIG. 1.

### EXAMPLE 2

The same procedure as in Example 1 was performed with the exception that 90 g of the seed particles were fed in an early stage of the polymerization reaction. The analysis results of size distribution are given in FIG. 2. As seen in FIG. 2, particles smaller than 1 μm or larger than 40 μm in size are not observed in the microbeads.

### COMPARATIVE EXAMPLE 1

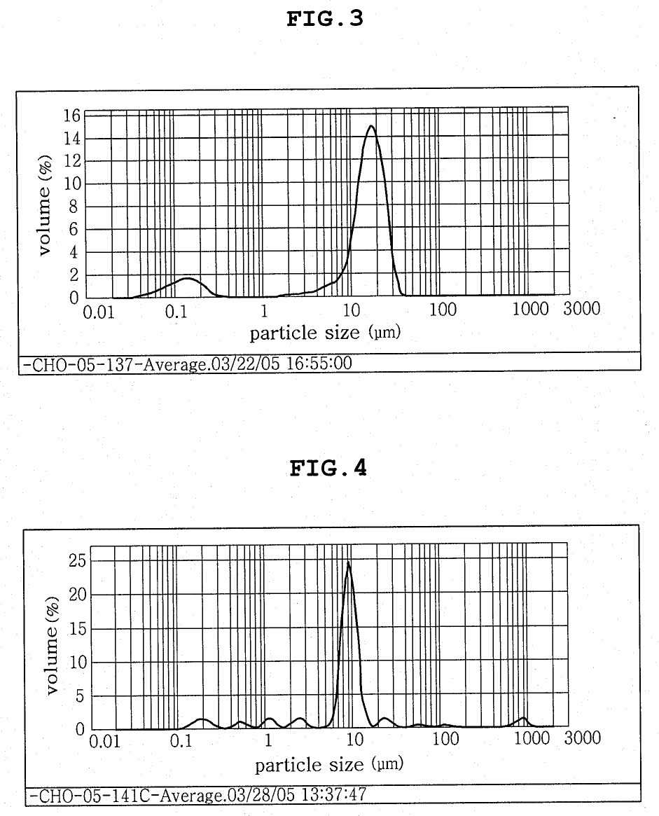

Microbeads were prepared in a manner similar to that of Example 1, with the exception that no seed particles were supplied. The analysis results of size distribution are shown in FIG. 3.

### COMPARATIVE EXAMPLE 2

The same procedure as in Example 2 was conducted, with the exception that monodisperse seed particles with a weight average molecular weight of about 250,000 were supplied. The analysis results of size distribution are shown FIG. 4.

As apparent by comparing the data of Comparative Examples 1 and 2 with the data of Examples 1 and 2, the microbeads according to the present invention are free of particles smaller than 1 μm or larger than 40 μm and show a much narrower particle size distribution than do the conventional microbeads.

On one hand, the product solutions obtained in Examples and Comparative Examples were allowed to stand for 24 hours, and the supernatants were measured for solid content using Sartorius MA 50 to determine the contents of fine particles which had not settled. After decanting the supernatants, a process of adding 4 kg of water warmed to 70° C., stirring for 30 min, and decanting the water to remove fine particles and the dispersants was repeated three times. The residues were dried in an oven in a vacuum to measure the production yield. Contents of fine particles and recovery rates of microbeads are given in Table 1, below. As seen in Table 1, the addition of the seed particles significantly reduces the production of fine particles while improving the recovery rate of microbeads. As for the content of fine particles of Comparative Example 2, it was not measured because fine and coarse particles were produced simultaneously in Comparative Example 2.

TABLE 1
Contents of Fine Particles and Recovery Rates of Microbeads

| | Content of Fine particle | Recovery Rate of Microbeads* |
|---|---|---|
| Ex. 1 | 0.24% | 87.3% |
| Ex. 2 | 0.27% | 86.9% |
| C. Ex. 1 | 5.32% | 82.4% |
| C. Ex. 2 | — | — |

*based the weight of the monomer used.

1. A method of preparing acryl microbeads through polymerization by stirring a polymerization composition containing vinyl acrylate monomers, an initiator and a dispersion stabilizer at a high speed to form microdroplets and increasing a reaction temperature to induce a polymerization reaction of the monomers within the microdroplets, wherein a low molecular weight seed particle capable of absorbing vinyl acrylate monomers dissolved in a reaction medium outside the microdroplets is fed upon the polymerization reaction such that the acryl microbeads have a narrow particle size distribution.

2. The method according to claim 1, wherein the seed particle is fed within 30 minutes to 1.5 hours after the reaction temperature reaches 65° C. to 70° C., at which temperature the monomers are polymerized inside the microdroplets but are not polymerized in the reaction medium.

3. The method according to claim 1, wherein the seed particle ranges in weight average molecular weight from 10,000 to 200,000.

4. The method according to claim 1, wherein the seed particle is synthesized by polymerizing one member selected from the group consisting of methylacrylate, ethyl acrylate, normal propylacrylate, isopropylacrylate, butylacrylate, styrene, para alkylstyrene, meta alkylstyrene, meta halostyrene, para halostyrene, acrylonitrile, acrylamide, and N-vinyl-2-pyrrolidone.

5. The method according to claim 1, wherein the vinyl acrylate monomer is selected from the group consisting of methyl (meth)acrylate, ethyl (meth)acrylate, normal propyl (meth)acrylate, isopropyl (meth)acrylate, butyl (meth)acrylate, ethyleneglycol di(meth)acrylate, propyleneglycol di(meth)acrylate, pentaerythriotoltri(meth)acrylate and combinations thereof.

6. Acryl microbeads prepared according to the method of claim 1 free of particles smaller than 0.5 μm or larger than 50 μm, and ranging in particle size from in particle size from 1 to 50 μm.

7. Acryl microbeads prepared according to the method of claim 2, free of particles smaller than 0.5 μm or larger than 50 μm, and ranging in particle size from 1 to 50 μm.

8. Acryl microbeads prepared according to the method of claim 3, free of particles smaller than 0.5 μm or larger than 50 μm, and ranging in particle size from 1 to 50 μm.

9. Acryl microbeads prepared according to the method of claim 4, free of particles smaller than 0.5 μm or larger than 50 μm, and ranging in particle size from 1 to 50 μm.

10. Acryl microbeads prepared according to the method of claim 5, free of particles smaller than 0.5 μm or larger than 50 μm, and ranging in particle size from 1 to 50 μm.
